(19) United States
(12) Patent Application Publication
(10) Pub. No.: US 2003/0145315 A1
(43) Pub. Date: Jul. 31, 2003

(54) Exchange of data between components of distributed software having different versions of software

(76) Inventors: Tuomo Aro, Antibes (FR); Henri Sara, Valbonne (FR)

Correspondence Address: PILLSBURY WINTHROP, LLP, P.O. BOX 10500, MCLEAN, VA, 22102, US

(21) Appl. No.: 10/052,242

(22) Filed: Jan. 23, 2002

(51) Int. Cl. G06F 9/44

(52) U.S. Cl. 717/170

(57) ABSTRACT

The present invention relates to exchanging data between software components in a distributed software system comprising a first software component and a second software component. A first data exchange metadata description is provided that contains information on data structures used in a serialized data exchange by the first software component. A dedicated second data exchange metadata description is provided for each older version of the second software component, each second data exchange metadata description containing information on data structures to be used in a serialized data exchange by the second software component. As a consequence, the first software component having a newer version is able to exchange data with any of the older second software components by using the respective data exchange metadata in data serialization and deserialization.

### FIELD OF THE INVENTION

The present invention relates generally to distributed software systems, and particularly to co-operation between different components of distributed software having different versions of the software.

### BACKGROUND OF THE INVENTION

A software system having software components installed apart from each other and exchanging data with each other is called a distributed software system. An example of a distributed software system or distributed computer system is a ‘client-server’ relationship in which the execution of a task is divided between different functional entities (i.e. computer processes or software components) which are specialized in different parts of the task so that one functional entity uses a service provided by another. The process requesting the service is called a ‘client’ and the provider of the requested service is called a ‘server’. Typically, the server software component(s) and the client software component(s) are installed on separate computers called server computers and client computers, respectively. Alternatively, the server software component(s) and the client software component(s) may be different software processes running in the same computer device.

The components of distributed software are not necessarily updated all at once. Especially when the software is divided to server component(s) and to client component(s), the number of client component(s) installed tends to be high and simultaneous update of all of them is not possible. When client components are installed into portable computers, or computers otherwise behind possible slow-speed connections, updating the client component is not always an eligible option.

U.S. Pat. No. 5,915,112 discloses a distributed computer system wherein a client computer process can request the execution of a remote procedure on a server computer process even when the server computer process does not support a current version of the client computer. The remote procedure requests are based on remote procedure calls (RPC's) which are typically defined using a remote procedure interface. U.S. Pat. No. 5,915,112 proposes an extended remote procedure interface, which maps each remote procedure defined in the interface to prior versions of the remote procedure. This enables client computer processes to utilize a version map from the interface when requesting the execution of remote procedures so that the requests are in a format supported by the server computer processes executing the remote procedures, regardless of the versions of the remote procedure interface in the client and server processes. In other words, U.S. Pat. No. 5,915,112 discloses algorithms explicitly written to provide an adaptation between different versions of the remote procedure interfaces of the client and server processes. These algorithms check the compatibility between the remote procedure interfaces separately for each RPC request, which is capacity-consuming since a significant number of RPC requests is typically involved with each user session. Further, such explicit algorithms are susceptible to errors and laborious to maintain. The susceptibility to errors is particularly a consequence of the fact that any change in a data structure does not propagate to the adaptation algorithms unless the programmer remembers to make the necessary changes in the algorithms. If the algorithms are not reprogrammed to take into account the change in the data structure, the system will be unstable. In other words, a version mapping is manually written for previously known software versions. In practice, this involves quite a difficult binding of the algorithms and mapping to version-specific interface definitions. Finally, in the system according to U.S. Pat. No. 5,915,112, the client process must have means for being compatible with the server process.

International patent application WO 00/75784 discloses software translation using metadata. In this prior art, too, the metadata is written for previously known versions so that the metadata as such is a map between the differences of these versions. Thus, the metadata must include explicit transformation definitions. This approach is laborious to implement in practice and a complicated solution that makes application development inflexible and does not support the rapid cycle development of a product that consists of separate components exchanging data with each other.

### A SUMMARY OF THE INVENTION

An object of the invention is to provide a more reliable and flexible method for enabling different components of distributed software having different versions of the software to co-operate.

The basic idea of the invention is to serialize data between different components of distributed software by using data exchange metadata descriptions. Serialization is used in transferring data from one component to another. In other words, data is serialized at a sending end, transferred to a receiving end, and deserialized at the receiving end. In a preferred embodiment of the invention, serialization is an operation wherein data content of a data object is transformed into a stream of bits. The bit stream can be respectively deserialized in order to reconstruct the data content into a compatible data object at the receiving end. The data exchange metadata description of a software component version comprises information on definitions for data structures to be serialized of the specific software component version. A dedicated data exchange metadata description is produced for each software version that is delivered.

A delivery version of a counterpart version is identified, preferably in the beginning of a data exchange, by the software component having a newer version. The newer version is responsible for loading the data exchange metadata of the counterpart version and for using the data structures of the counterpart in both serialization and deserialization. Thus, the software component having a newer version is able to exchange data with any compatible counterpart software component by means of the data exchange metadata of the respective component in data serialization and deserialization. The older version does not need to take further measures for compatibility. As a result, the present invention enables reliable and convenient backward compatibility and true flexibility for updating the components of distributed software.

An advantage of the present invention is that there is no need to write a version-specific mapping algorithm separately for each pair of known counterpart software versions in the manner required in the prior art. As a consequence, the need to maintain explicit mapping algorithms used in the prior art, as well as the associated problems, are also avoided. Thus, delivery of a new software version does not require a new mapping algorithm for each older version. Instead, in the present invention it is only necessary to provide, preferably automatically, a metadata description of the relevant data structures of the new software version. The actual mapping, called a serialization scheme herein, is then created, and preferably also verified, automatically between the new software version and any older counterpart software version by means of a universal algorithm and the metadata descriptions of these two component versions, either prior to delivery or subsequent to the delivery. The present invention also improves the overall performance because very few additional steps are needed in the algorithms, and the data stream itself does not have to carry any version and/or structure information.

In an embodiment of the invention, a delivery of a new version includes only the data exchange metadata description of that new version, and the data exchange metadata descriptions of compatible versions of the counterpart software component(s) are delivered later, for example in the data exchange session with the respective version. In another embodiment, the data exchange metadata descriptions for substantially all compatible versions of the counterpart software component(s) are delivered with each new version of a software component, in addition to the data exchange metadata description of that new version.

In an embodiment of the invention, the serialization scheme is preferably prepared and stored by the installed new software version when a data exchange with an older version of a counterpart component is carried out first time. In another embodiment, the serialization scheme can be prepared and stored automatically beforehand. In a yet further embodiment, the serialization scheme is prepared for at least one pair of software versions prior to the delivery of a newer version, and delivered with the new software version instead of or in addition to the data exchange description(s).

In the present invention, the data exchange metadata description is tied to the delivery versions of software components thus enforcing compatibility between complete installed entities. This approach helps to isolate version compatibility checking and to reduce the number of versions to take into account within a single data exchange operation. Version compatibility can be checked in a most reliable manner using the data exchange metadata of the delivery versions, assuming that the data structures used for data exchange match those used inside application programs. As an advantage of the relationship between the delivery version and the data exchange metadata, version compatibility checking is a simple, isolated operation. It usually occurs only once, in the beginning of a client component session, prior to data exchange.

In a client-server concept, the newer software component version is typically a server component and the older counterpart software component is a client component. The present invention enables reliable and convenient backward compatibility for components of distributed software without compromising performance. Client component updates are not necessary immediately after a server component has been updated. Being able to use a client component of an older version improves usability as users then have a lot more flexibility on choosing when to upgrade the client components. It also allows accessing server components of different versions with a single client component. Another advantage of performing compatibility measures on the newer version side is being able to immediately use new compatibility measures also for any old versions.

The serialization scheme may be built by request or during the first serialization of a given data object. Building a serialization scheme according to the invention involves analyzing the object including the definitions of all ancestors and referred objects. It is a relatively heavy operation but takes place only once. The invention provides fast communication since serialization operations are fast and straightforward as they only utilize the prepared serialization schemes. Further, when only the essential primitive contents are serialized, the serialization performance increases and message size decreases accordingly.

### BRIEF DESCRIPTION OF THE DRAWINGS

The invention will now be described in more detail by means of preferred embodiments of the invention and with reference to the attached drawings, in which:

FIG. 1 illustrates a client-server architecture;

FIG. 2 is a flow chart illustrating the delivery of a new software component according to an embodiment of the present invention;

FIGS. 3A and 3B are flow charts illustrating an algorithm for writing a metadata description according to an embodiment of the invention;

FIGS. 4A and 4B are flow charts illustrating an algorithm for compatibility verification between different software versions according to the present invention;

FIG. 5 is a block diagram illustrating data exchange between an older version of a client component and a newer version of a server component;

FIG. 6 is a flow chart illustrating the general steps of preparing serialization, and serialization and deserialization,

FIG. 7 is a flow chart illustrating the process for preparing the serialization,

FIGS. 8A and 8B are flow charts illustrating the serialization operation, and

FIGS. 9A and 9B are flow charts illustrating the deserialization operation.

### PREFERRED EMBODIMENTS OF THE INVENTION

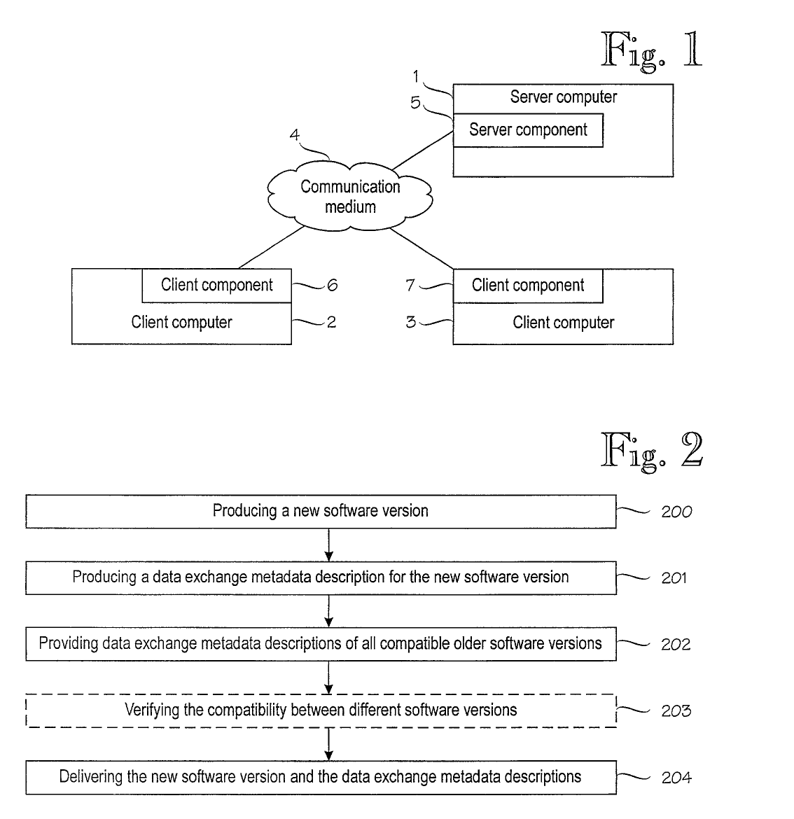

The present invention can be applied to any distributed software system, in which different components of distributed software having different versions of the software must co-operate, i.e. exchange data with each other. An example of a distributed software system is a server-client concept which is illustrated in FIG. 1. In the server-client architecture, the software is divided into server component(s) 5 and client component(s) 6 and 7 installed in server computer(s) 1 and client computer(s) 2 and 3, respectively, apart from each other. Alternatively, the server software component(s) and the client software component(s) may be different software processes running in the same computer device. The server components and the client components communicate with each other via any appropriate communication medium 4 depending on implementation. The type of the communication medium is not relevant to the present invention. Examples of suitable communication media include various communication networks, communication links, a storage medium, and a shared memory. The invention will be now described by using the client-server architecture as an example, but the present invention is not restricted to client-server systems.

Firstly, concepts of serialization, deserialization, structural data, and a metadata description are briefly explained in order to facilitate understanding the invention.

Serialization and Deserialization

Serialization is an operation used in transferring data from one component to another. That is, data is serialized at the sending end, transferred to a receiving end and then deserialized at the receiving end. Serialization is the operation where the data content of a data object is transformed into a stream of bits that may be formatted into bytes. The bit/byte stream can be respectively deserialized in order to reconstruct the data content into a compatible data object. The format of the bit/byte stream can be simplified and/or compressed in order to improve performance or it can be a tagged text format, such as XML, in order to make it readable to different systems or by humans.

In an embodiment of the invention, not only actual data, but also information about a source data object can be included into serialized data in order to support the checking of compatibility against a target data object or just to help examine the byte stream. If data is recursive or if the data structures are known only at run time, they can be identified in the byte stream and allocated respectively at deserialization. In order to prevent serializing the same data multiple times, each data structure instance may be assigned a unique identifier in the complete byte stream context. When a data structure instance is encountered again during the same serialization or deserialization operation, only a reference to it can be processed, instead of processing the instance again.

Structural Data

When a data item contains more than a single value (a number, a string or a fixed binary block), data transfer is easier to manage by processing it as a structural entity rather than transferring each value separately. A structure can be simply a fixed set of values, each having a known data type. Serializing such structures is quite a simple operation but has such limited characteristics that they are not very useful.

Common, more advanced characteristics for structural entities include:

Defining structures as a set of items where an item can be defined to have a simple or structural type. Structures can be nested inside each other.

Defining items optionally as arrays. An array may have a fixed size or a variable size and a limit for a maximum number of elements. The array implementation may be limited to only one dimension or it may support multiple dimensions.

Defining some or all data items optional so that instead of always containing a value, the data item may contain just an indication of a missing value.

Defining some data items to be alternative or optional according to a separate discriminant value. In a structure containing a set of alternative items (such as a union of the programming language C), the discriminant value determines which item is used. The discriminant value can also be for example a bit mask where each bit determines the existence of the respective item.

Defining the structures as classes in an object-oriented design, thus having the definitions of a possible super class acknowledged for each class.

A loose-type relationship between declared data items and data items actually passed. The data item could simply refer to any structural entity. In an object-oriented design, an instance of a subclass could be passed instead of an instance of the declared class.

A combination of the above features can be used to pass for example lists with elements of different types or recursively nested structures.

Data Exchange Metadata

The serialization of structural data requires access to information on definitions of the structures to serialize. With the assumption that serialization is mainly used for exchanging data, that information is referred to here as data exchange metadata.

Producing New Software Version

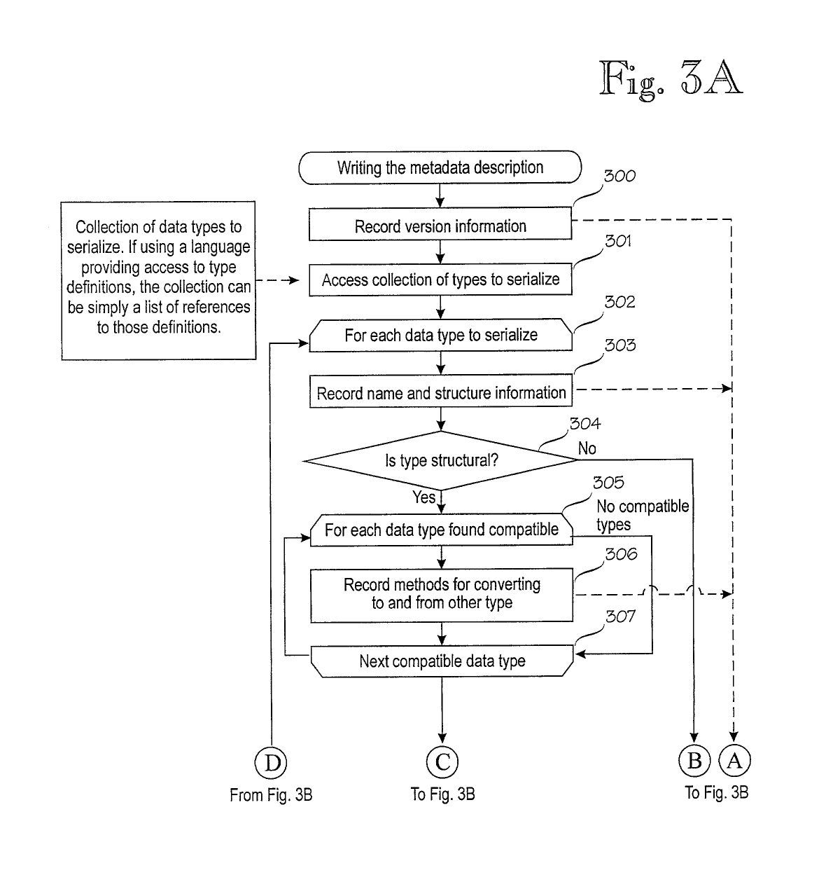

Referring now to FIG. 2, let us assume that a new version of distributed software is produced (step 200). Quite often an update to a distributed software system means adding a new functionality and retaining an existing functionality. In such case, it is likely that the client components of the previous software version are functionally compatible with the new version of a server component but the data structures exchanged between the components may have changed. Thus, in many cases where the new functionality of the server component is compatible with the functionality of the old client components, with the exception of modifications to the data structures, the new server component can co-operate with such old client components assuming that the server component fully accepts the data structures and items in the way they were defined for the client component, i.e. the server component must have available the data exchange metadata descriptions according to the invention.

Thus, for example, if the data exchange metadata description is produced for each software version that is delivered, and the data exchange metadata descriptions of all compatible versions are delivered with each software version, the server component is able to exchange data using the data exchange metadata of any compatible client component.

However, in order to maintain backward compatibility, all the services offered and data structures used with previous versions must be kept available. The data structures can be modified but the data items must be found by using old names, and the types of the data items must be kept backward compatible (convertible). For any removed or added item, there must be a way to determine a default value. In case there is any need for renaming the data structures or the data items in them, the name changes must be declared to complement the metadata information. The declaration is necessary so as to find the matching structure or item using the old name.

Producing a Data Exchange Metadata Description

In accordance with the present invention, data exchange metadata descriptions are produced both for the components of the new software version (step 201) and for all older software versions which should be compatible (step 202). There are various ways to produce the metadata descriptions.

In applications using serialization, the data structures used in the programs are usually similar to those used in the serialization. In such a case, the data exchange metadata is most often based on a common source code for both uses. When the applications sharing serialized data are separate from each other, and possibly not implemented using the same programming or scripting language, the data exchange metadata can be described using a tool or language (e.g. CORBA IDL, ISO/IEC 14750) dedicated to describing such metadata. When using a programming language that provides access to the metadata of language objects, the source of the data exchange metadata can be simply a part of the program source code.

If the data exchange metadata is deduced from type definitions of a program source code, the definitions should be distinguishable from other definitions. If they are not distinguished, that information is difficult to manage and it does not help in the verification of compatibility between software versions. In practice, the difficulty in managing this information means scanning it multiple times during the serialization and deserialization operations, thus severely compromising performance.

The data exchange metadata must have a defined description format in order to be able to permanently store it and to restore it to the software. The details of the format are not significant.

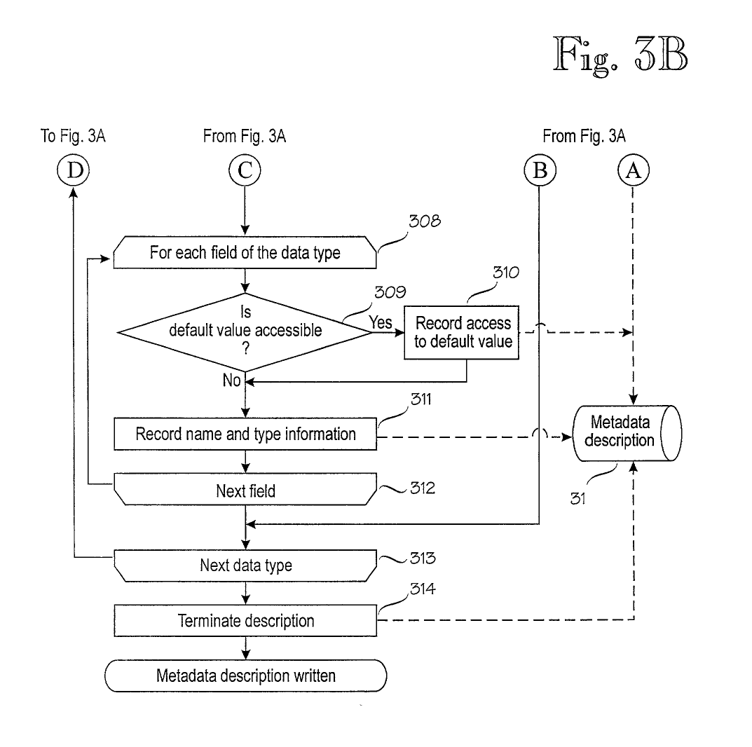

An example of an algorithm for writing a metadata description according to an embodiment of the invention will now be described with reference to FIGS. 3A and 3B. The metadata description reflects the data type description information required for a backward compatible serialization. The syntax of data can be freely chosen. The preferred source of metadata information is the definition of the data types in terms of the programming language. This is possible only with programming languages providing access to the type definition. Firstly, in step 300, information about the delivery version of the new software component is recorded to the metadata description. It should be noted that in FIGS. 3A and 3B, the dotted lines represent writing operations to the metadata description 31. Then, a collection 30 of data types to be serialized is accessed in step 301. If a language providing access to the type definitions is used, the collection 30 can be simply a list of references to those definitions. Steps 302 to 313 are then performed for each data type to be serialized. Firstly, the name and structure information is recorded to the metadata description 31 (step 303). Then, it is checked (step 304) whether the data type is structural or not. If the data type is not structural, the process proceeds directly to step 313 and then returns to step 302 to handle the next data type. However, if the data type is structural, methods for converting the respective data type to and from another data type are recorded to the metadata description 31 for each data type found compatible (steps 305, 306 and 307). Then, it is checked for each field of the data type whether a default value is accessible (steps 308 and 309). If a default value is accessible, the access to the default value is recorded to the metadata description 31 (step 310), whereafter the process continues by recording the name and type information of the field to the metadata description 31 (step 311). If the default value is not accessible in step 309, the process moves directly to step 311. When all fields of the data type have been processed in step 312, the next data type is processed via step 311. When all data types have been processed in step 313, the metadata description 31 is terminated in step 314.

Compatibility Verification

After the data exchange metadata descriptions have been provided, the compatibility between different software versions may be verified (step 203 in FIG. 2). Compatibility verification can be performed as a part of the development work in order to know if the given versions have serialization compatibility. Preferably, compatibility verification is performed using an automatic verification algorithm when preparing the version delivery. Version compatibility can be checked in a most reliable manner by using the data exchange metadata of the delivery versions, assuming that the data structures used for the data exchange match those used inside the application programs. The verification algorithm is executed against the data exchange metadata descriptions of previous deliveries as far as compatibility is considered necessary. The verification algorithm loads in the data exchange metadata for the current version and for the version to compare it with. The algorithm compares the name and type information of data structures and makes sure that all compatible structures still exist, that data items with compatible types exist and that for each removed and added data item, there is a way to determine a default value.

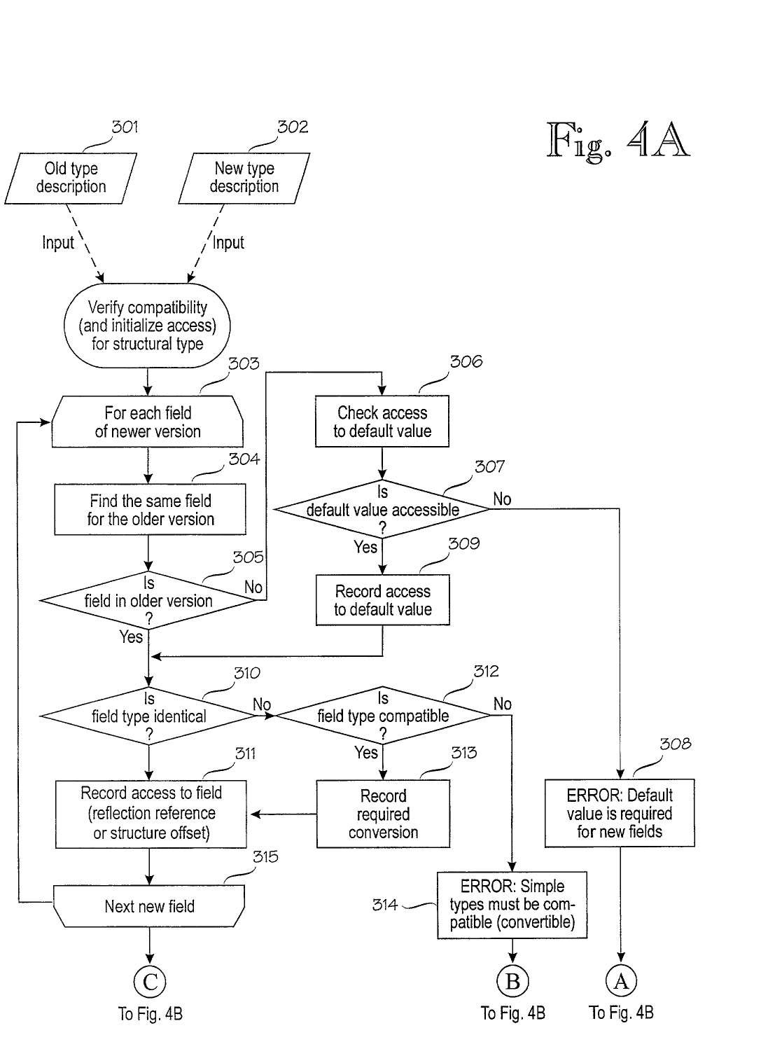

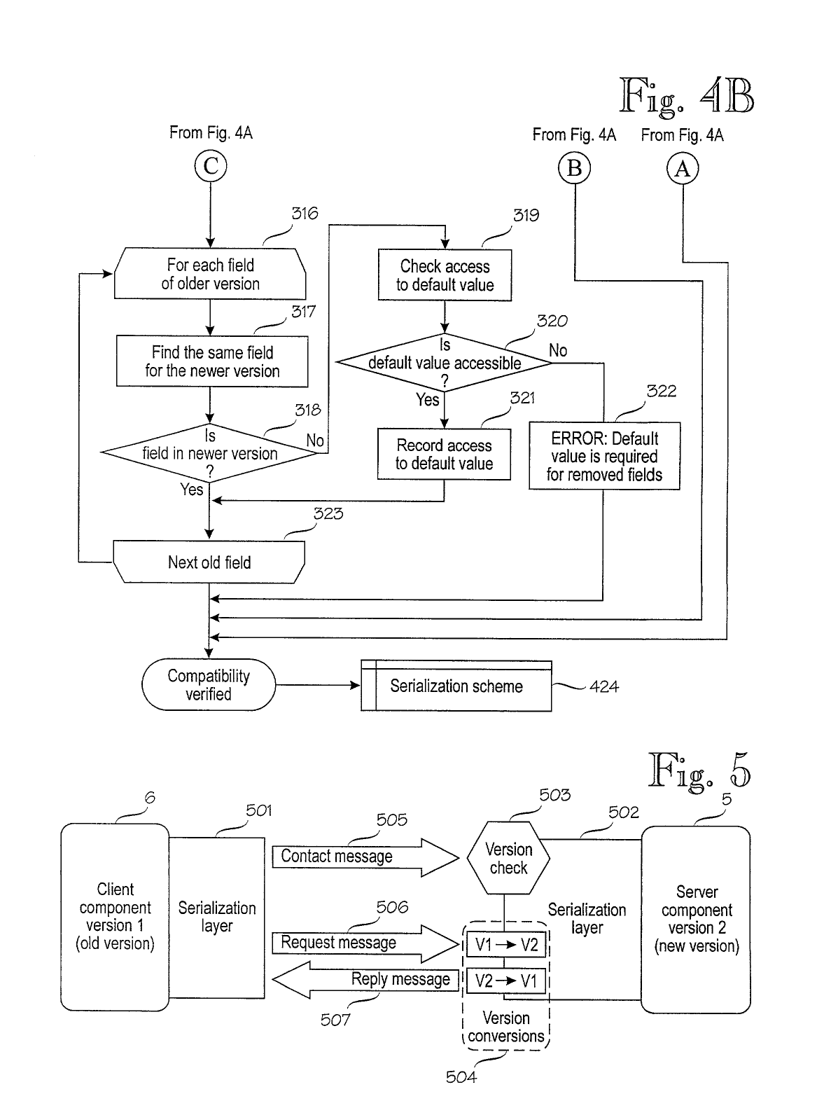

An example of the verification algorithm is shown in FIGS. 4A and 4B. In this example, when the verification is performed in order to serialize data between different versions, the exemplary algorithm also prepares access to the data items in the host language. The details of such preparation depend on the programming language used.

The algorithm of FIGS. 4A and 4B illustrates steps for verifying compatibility for one structural type, i.e. it must be repeated separately for each different structural type. Firstly, the metadata description 401 for the old structural type (of the old version) and the metadata description 302 for the new structural type (of the new software version) are inputted (loaded) to the verification algorithm. Then, for each field of the newer version of the structural type, it is checked whether the same field can be found in the older structural version (steps 303, 304 and 305). If the specific field is not found in the older version, i.e. a new field has been added to the new version, it is checked whether a default value for such a field is accessible (steps 306 and 307). If such a value is not accessible, an error message is generated indicating that a default value is required for the new field. Upon receiving the error message from the algorithm, the software developer can define an appropriate default value which is preferably stored to the metadata description of the newer version. If the default value is accessible in step 307, the access to the default value is recorded in step 309, and the algorithm proceeds to step 310. If the field of the newer version can be found in the older version in step 305, the algorithm proceeds directly to step 310.

In step 310, it is checked whether the field types are identical in the newer and older versions. If the check is affirmative, the access to the field (a reflection reference or a structure offset) is recorded in step 311. However, if the field types are not identical, it is checked whether the field type of the older version is compatible with the field type of the newer version (step 312), and the algorithm proceeds to step 311. However, if the field types are not compatible in step 312, the algorithm generates an error message indicating that the field types must be compatible (convertible). Upon receiving the error message, the program developer can perform an appropriate measure to remove the error situation, if possible.

After step 311, it is checked whether there are more fields in the newer version to be verified (step 315). If yes, the algorithm returns to step 303. If not, the algorithm proceeds to step 316 to verify each field of the older structural-type version. Firstly, it is checked whether the field of the older version can be found in the newer version (steps 317 and 318). If the same field cannot be found in the newer version, it is checked whether a default value for this field is accessible (steps 319 and 320). If a default value is accessible, the access to the default value is recorded (step 321), and the algorithm proceeds to step 323. However, if a default value cannot be accessed, the algorithm generates an error message indicating that a default value required for the removed field is missing (step 322). Upon receiving the error message (step 322), the software developer can carry out an appropriate measure to remove the error situation. After step 380, it is checked whether there are more fields to verify in the older structural version. If there are more fields, the algorithm returns to step 316. If all fields have been verified, the compatibility verification has been completed. The serialization algorithm results in a serialization scheme 424, as will be explained in more detail below. This serialization scheme can be delivered with the new software version, instead of or in addition to the data exchange metadata description(s) of the newer version, and optionally the metadata description(s) of the older version(s).

The same verification algorithm can also be used when preparing the serialization process in an installed server component on the basis of the metadata descriptions. However, when the algorithm is used for preparing the serialization, no error messages should be generated, since any error situation has been detected and corrected already during the verification prior to the delivery of the new software version.

Thus, this aspect of the present invention enables version compatibility to be checked automatically in a very reliable manner by using the data exchange metadata of the delivery versions. Most of the error situations can be detected and corrected before the delivery.

Delivery of New Software

The serialization scheme(s) and the data exchange metadata description of the new software version and of compatible software versions can be delivered with the specific software version (step 204), in which case they are stored in the server computer 1 during the installation of the new server component 5. However, especially if the data exchange metadata of the older version comprises a relatively small amount of information, it can be alternatively passed in a session handshake procedure (instead of delivering all the data exchange metadata descriptions or serialization schemes with each new version), thus determining the compatibility at run time. The data exchange metadata may be obtained from the counterpart software component, or it may be retrieved from a centralized database.

Data Exchange Using Serialization and Deserialization with Metadata Descriptions

FIG. 5 is a block diagram illustrating a data exchange session between an older client component (version v1) and a newer server component (version v2). In the exemplary configuration shown in FIG. 5, separate serialization layers 500 and 501 are also shown. Implementation of the serialization layers 501 and 502 for a remote service calling typically necessitates that the remote call API (Application Programming Interface) is kept backward compatible and that the serialization layers support the version of the local and remote component. In addition to a serialization version-compatibility verification described below, a call API compatibility verification may also be used.

In the embodiment shown in FIG. 5, the software component having the newer version (i.e. the server component 5) is responsible for all measures needed for achieving compatibility with the older version (i.e. the client component). To this end, the serialization layer 502 of the server component 5 includes appropriate operations, such as a version check 503 and version conversions 504. The client component of the older version v1 does not need to take any additional measures for compatibility, and therefore, the serialization layer 501 does not contain any extra operations for achieving compatibility with the newer version v2 of the server component 5. However, it is possible that in addition to backward compatibility, forward compatibility is supported by similar means. For example, an older server component may not offer all services that a newer version of a client component expects. Thus, the serialization layer 501 of the client component 6 may contain operations for achieving compatibility with such an older version of a server component.

The advantage of performing backward compatible serialization only in a more advanced counterpart of the data exchange is that the client component that needs to co-operate only with the server components of the same version or a later version does not need any modification or updating for achieving serialization compatibility. Another advantage of performing compatibility measures on the newer version side is being able to immediately utilize new features for communication with old versions that do have these features.

Version Check

Information about the delivery version of the software component must be passed in the beginning of the data exchange between the client and server components 5 and 6. For unidirectional transfer, the version is simply identified in the beginning of the byte stream. For bi-directional messaging, the first contact 505 within a data transfer session could be a handshake procedure where the version identifier is passed and the software components 5 and 6 get to know if and how they are compatible. Optionally, this procedure may also support client version updating whenever it is considered preferable.

Preparing Serialization

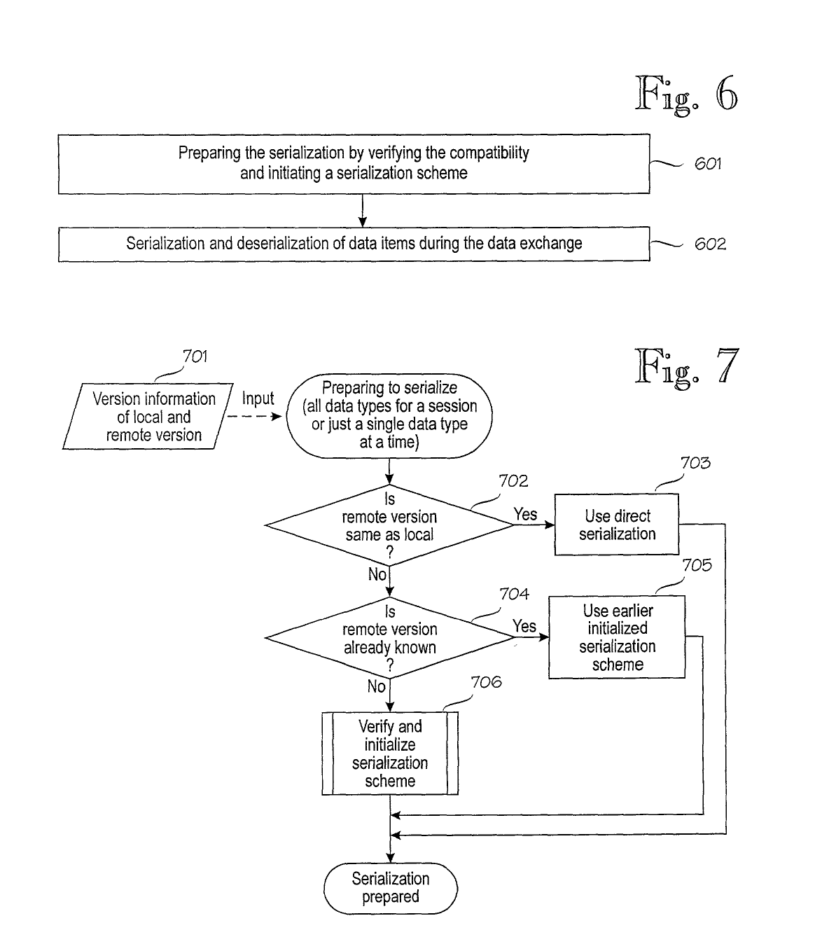

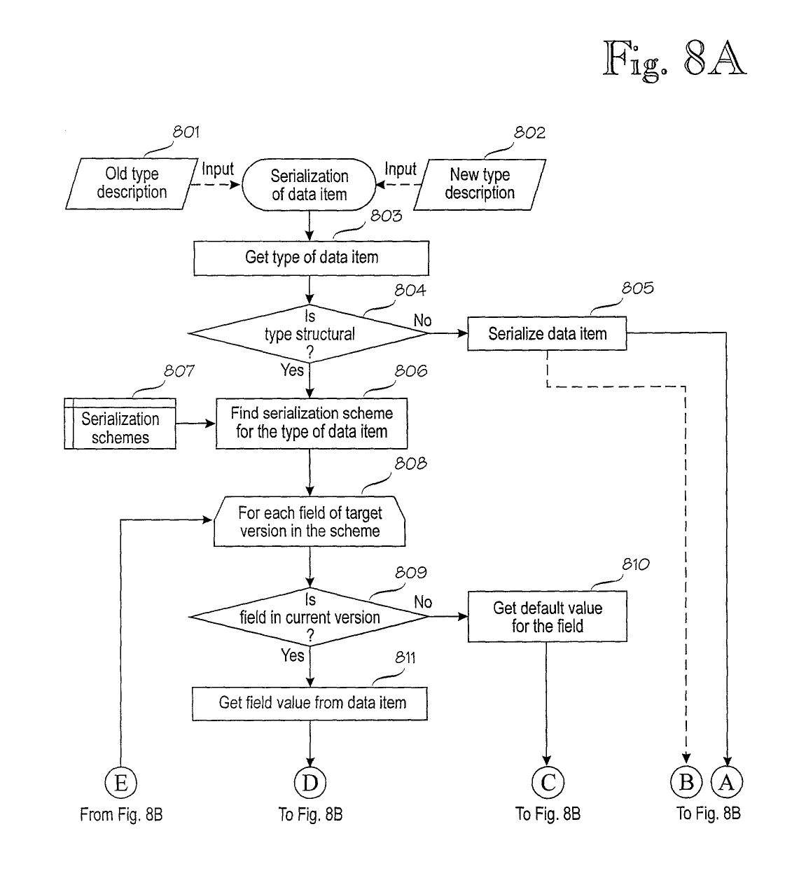

Referring to FIG. 6, serialization is prepared by verifying the compatibility and initiating a serialization scheme (step 601). Serialization can be prepared either by a single operation concerning all possible serialized data types, or by separate operations during the serialization of each data type. When this preparation is launched in order to verify the compatibility of the data types, it should be performed for all types to be serialized.

FIG. 7 is a flow diagram which illustrates the process for preparing the serialization. The server component 5 having the newer version v2 loads the version identifier of the local version (the version v2) and the remote counterpart version (the version v1). Then the version check procedure 503 of the server component 5 determines whether the remote version is the same as the local version (step 702). If the versions are the same, a direct serialization can be used and no further preparation of the serialization is needed (step 703). However, if the remote version and the local version (e.g. the client component version v1 and the server component version v2) are not the same, it is checked whether the remote version (e.g. version v2) is already known by the server component 5 (step 704). If the remote version is already known, i.e. a serialization scheme has already been initialized for this remote version (prior to a delivery or during a previous communication), this earlier initialized serialization scheme is used (step 705) and the preparation of the serialization is ended. However, if the remote version is not known, compatibility is verified and a serialization scheme is initialized for this version (step 706). After step 706, the preparation of the serialization is ended.

The verifying and initialization step 706 can be carried out by the algorithm described above with reference to FIGS. 4A and 4B. When compatibility has been successfully verified, the algorithm results in an initialized serialization scheme 424. The serialization scheme contains information needed in the version v2 of the server component 5 for the serialization of data to and the deserialization of data from the client component 6 running the older version v1. The serialization scheme is typically prepared only once for each type of a certain target version and stored in memory. All types of a certain target version can be prepared at once.

Serialization and Deserialization

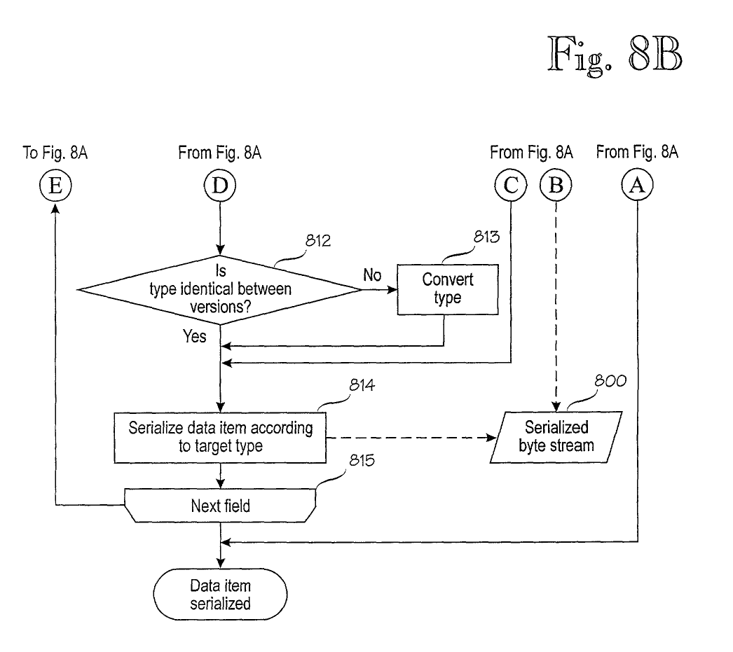

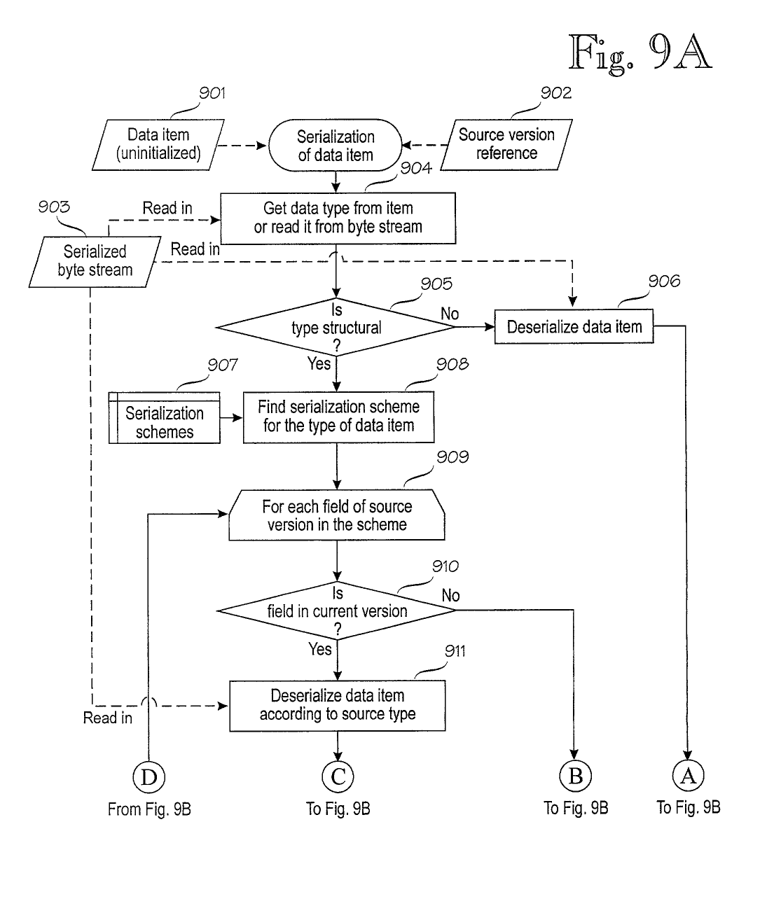

Referring again to FIG. 6: after the serialization has been prepared, the serialization and deserialization of the data items are performed during the data exchange (step 602). The serialization and deserialization operations are needed for each data item to be transferred. For remote services, the data items are a remote service parameter in the request message 506 and the return value(s) in the reply message 507 in FIG. 5. An example of a serialization process is illustrated by the flow chart shown in FIGS. 8A and 8B. The serialization is started by inputting the data item 801 to be serialized (received from the server component 5) as well as the target version identifier 802 indicating the version of the software with which the serialized data should be compatible. Then, it is checked whether the type of the data item 801 is structural or not (steps 803 and 804). If the type is not structural, the data item is serialized (step 805) and written out to the serialized byte stream 800, thereby completing the serialization of the specific data item. If the type of the data item 801 is structural, a serialization scheme for the type of the data item 801 is retrieved (806) from a serialization scheme memory 807. It is checked for each field of the target version v1 in the retrieved serialization scheme whether the respective field can be found in the current version v2 (steps 808 and 809). If a field cannot be found in the current version, a default value is kept for the specific field (step 810), and the process proceeds to serialize the data item 801 according to the target type (step 814) and to write out the field into the serialized byte stream 800. However, if the field can be found in the current version v2, the field value is obtained from the data item 801. Then, it is checked whether the types of the data items are identical in the two versions v1 and v2 (step 812). If not, a conversion of the type is carried out (step 813), and the resulting data item is serialized in step 814. If the types of the data items are identical in the two different versions v1 and v2, the data item is serialized in step 814. Then, in step 815, it is checked whether all fields of the target version v1 have been processed. If not, the process returns to step 808. If all fields have been processed, the serialization of the data item 801 has been completed. As a result, a serialized byte stream 800 is transferred from the server component 5 to the client component 6.

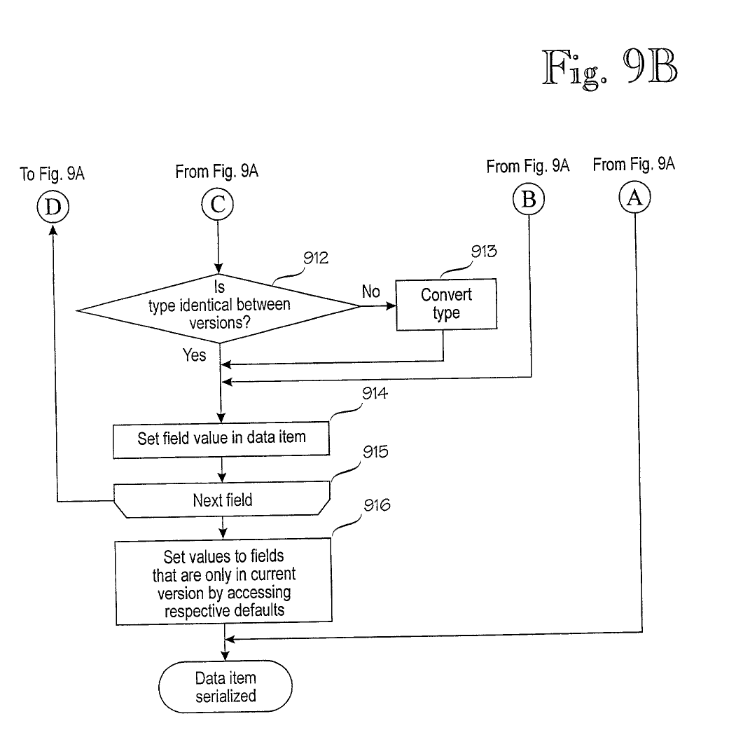

An example of a deserialization process is illustrated by a flow chart shown in FIGS. 9A and 9B. Firstly, an (uninitialized) data item 901 and source version identifier 902 are inputted to the deserialization process. Then the data type is obtained from the inputted data item 901 or read from a serialized byte stream 903 received from the client component 6 (step 904). Then, it is checked whether the type of the data item is structural (step 905). If the data type is not structural, the serialized byte stream is read in and the data item is deserialized (step 906). However, if the data type is structural, a serialization scheme for the specific type of the data item is loaded from the serialization scheme memory 907 (step 908) Then, it is determined for each field of the source version v1 in the serialization scheme whether the specific field is in the current version v2 or not (steps 909 and 910). If the specific field cannot be found in the current version v2, a value is set for the specific field in the data item (step 914). If the specific field is found in the current version v2, the serialized byte stream 903 is read in and the data item is deserialized according to the source type (step 911). Then it is checked whether the types of the data items are identical in the two versions v1 and v2 (step 912). If not, a conversion of the type is carried out (step 913), and the process continues to step 914. If the types are identical in the two versions v1 and v2, the process proceeds directly to step 914. After step 914, it is checked whether all fields of the source version in the serialization scheme have been processed (step 915). If not, the process returns to step 909. If all fields in the serialization scheme have been checked, the process is arranged to set values to fields that are only in the current version v2 by accessing respective default values (step 916).

The implementation of the serialization may have a significant influence in the performance of the software, because in addition to the resources consumed in the serialization and deserialization operations, the implementation also determines the size of the data stream exchange. The influence depends on how much the operations involve data exchange.

The key to a high performance is serializing only the essential data and nothing more. When data exchange metadata including all compatibility considerations is already known by all concerned components, only a short identifier needs to be serialized for each data structure instance instead of the complete structure of the metadata. As the version identifier is passed in the beginning of the contact, it does not need to be serialized.

Whenever possible, the data structures should be assigned permanent numeric identifiers that can be used to identify them instead of using names as identifiers. Using numerical identifiers saves resources especially in deserialization and reduces the length of serialized data. Whatever preparation the serialization or deserialization may require for each passed data structure, such preparation is preferably performed only once. The serialization and deserialization operations should preferably minimize the time consumed for anything else than for the byte stream conversions.

An Example

In the following, simplified examples of the metadata descriptions and serialization schemes are shown. In this simplified example, an application written in Java serializes a few structural data items (objects). The metadata description format in the example is XML.

The version 1 (v1) of the software has three classes to serialize and the version 2 (v2) has one additional class. Two of the classes have one new field in the version 2 in comparison with the version 1.

Version 1 Classes

Customer Class

package com.stonesoft.sample;
public class Customer

{String name;
String address;

}

Order Class

package com.stonesoft.sample;
public class Order

Customer customer;
Product product;

}

Product Class

package com.stonesoft.sample;
public class Product
{

| | |
|---|---|
| String | name; |
| String | reference; |
| int | priceCategory; |

}

Version 1 Metadata Description

This description can be produced using the algorithm shown in FIGS. 3A and 3B.

<METADATA_DESCRIPTION version=“v1”>

<TYPE name=“Customer” structural=“yes”>

<FIELD name=“name” type=“native:String”/>
<FIELD name=“address” type=“native:string”/>

</TYPE>
<TYPE name=“Order” structural=“yes”>

<FIELD name=“customer” type=“custom:Customer”/>
<FIELD name=“product” type=“custom:Product”/>

</TYPE>
<TYPE name=“Product” structural=“yes”>

<FIELD name=“name” type=“native:String”/>
<FIELD name=“reference” type=“native:String”/>
<FIELD name=“priceCategory” type=“primitive:int”/>

</TYPE>

</METADATA_DESCRIPTION>

Version 2 Classes

The Address class has a special constructor and toStringo method for enabling compatibility with the String type.

Address Class

package com.stonesoft.sample;
public class Address
{

| public static final int POSTAL_CODE_LENGTH = 5; // Constant; not serialized | |
|---|---|
| String | streetAddress; |
| String | postalCode; |
| String | city; |
| String | country; |

/**
* <P>Constructor for supporting conversion from address as String.
* <P>The parts of address are separated according to finding the
* postal code.
*/
public Address (String pAddress)
{

int postalCodeOffset = 0;
int offset = 0;
int postalCodeLength = 0;
boolean isPostalCodeFound = false;
while ( (!isPostalCodeFound) &&

(offset < (pAddress.length( ) − POSTAL_CODE_LENGTH)) )

{

char currentChar = pAddress.charAt(offset);
if (Character.isSpace(currentChar))
{

postalCodeOffset = offset + 1;

}
if ( (postalCodeOffset != 0) && (Character.isDigit(currentChar)) )
{

while ( (postalCodeLength < POSTAL_CODE_LENGTH) &&

(Character.isDigit(pAddress.charAt(

offset + postalCodeLength))) )

{

postalCodeLength++;

}
isPostalCodeFound = (postalCodeLength == OSTAL_CODE_LENGTH);

}
offset++;

}
if (isPostalCodeFound)
{

while ( (postalCodeLength < (POSTAL_CODE_LENGTH * 2)) &&

(!Character.isSpace(pAddress.charAt(

postalCodeOffset + postalCodeLength))) )

{

postalCodeLength++;

}
streetAddress = pAddress.substring(0,postalCodeOffset).trim( );
postalCode = pAddress.substring(postalCodeOffset,

postalCodeOffset + postalCodeLength).trim( );

int countryOffset = pAddress.indexOf(“\n”,postalCodeOffset);
int cityOffset = postalCodeOffset + postalCodeLength;
if (countryOffset == −1)
{

city = pAddress.substring(cityOffset).trim( );
country = “”;

}
else
{

city = pAddress.substring(cityOffset,countryOffset).trim( );
country = pAddress.substring(countryOffset).trim( );

}

}
else
{

streetAddress = pAddress;
postalCode = “”;
city = “”;
country = “”;

}

}

| /** | |
|---|---|
| * Default constructor. | |
| */ | |
| public Address( | String pStreetAddress, |

String pPostalCode,
String pCity,
String pCountry)

{

streetAddress = pStreetAddress;
postalCode = pPostalCode;
city = pCity;
country = pCountry;

}
/**
* Conversion to string from internal format.
*/

public String toString( )

{

return streetAddress + “\n” + postalCode + “ ” + city + “\n” + country;

}

}

Customer Class

package com.stonesoft.sample;
public class Customer
{

| | |
|---|---|
| String | name; |
| Address | address; |
| int | priority; |

/**
* Default value for priority field, this method is used by convention.
*/

public int getDefault_priority( )

{

return 5;

}

}

Order Class

package com.stonesoft.sample;
public class Order
{

| | |
|---|---|
| Customer | customer; |
| Product | product; |
| int | quantity; |

/**
* Default value for quantity field, this method is used by convention.
*/
public int getDefault_quantity( )
{

return 1;

}

}

Product Class

package com.stonesoft.sample;
public class Product
{

| | |
|---|---|
| String | name; |
| String | reference; |
| int | priceCategory; |

}

Version 2 Metadata Description

This description is produced using the algorithm presented in FIGS. 3A and 3B.

<METADATA_DESCRIPTION version=“v2”>

<TYPE name=“Address” structural=“yes”>

<COMPATIBLE_TYPE name=“String”>

<CONVERT_TO by_method=“toString”/>
<CONVERT_FROM by_constructor/>

</COMPATIBLE_TYPE>
<FIELD name=“streetAddress” type=“native:String”/>
<FIELD name=“postalCode” type=“native:String”/>
<FIELD name=“City” type=“native:String”/>
<FIELD name=“Country” type=“native:String”/>

</TYPE>
<TYPE name=“Customer” structural=“yes”>

<FIELD name=“name” type=“native:String”/>
<FIELD name=“address” type=“custom:Address”/>
<FIELD name=“priority” type=“primitive:int”>

<DEFAULT_VALUE by_method=“getDefault_priority”/>

</FIELD>

</TYPE>
<TYPE name=“Order” structural=“yes”>

<FIELD name=“customer” type=“custom:Customer”/>
<FIELD name=“product” type=“custom:Product”/>
<FIELD name=“quantity” type=“primitive:int”>

<DEFAULT_VALUE by_method=“getDefault_quantity”/>

</FIELD>

</TYPE>
<TYPE name=“Product” structural=“yes”>

<FIELD name=“name” type=“native:String”/>
<FIELD name=“reference” type=“native:String”/>
<FIELD name=“priceCategory” type=“primitive:int”/>

</TYPE>

</METADATA_DESCRIPTION>

Serialization Scheme

This serialization scheme example describes the information needed in a component running version 2 for serializing data to and deserializing data from a component running version 1

As a result of serialization preparation (see FIG. 7 and FIGS. 4A and 4B), the serialization scheme used in serialization (see FIGS. 8A and 8B) and deserialization operations (see FIGS. 9A and 9B), contains the following information:

Customer; Structural, updated:

name; String, identical.

address; Was String, now Address, conversions: toString( ) method & constructor.

priority; int, new field, default value by getDefault_priority( ) method.

Order; Structural, updated:

customer; String, identical.

product; String, identical.

quantity; int, new field, default value by getDefault_quantity( ) method.

Product; Structural, identical:

name; String, identical.

reference; String, identical.

priceCategory; int, identical.

Even though the invention is described above with reference to the examples, it should be appreciated that the invention is not restricted to these examples but can be modified within the scope of the inventive idea disclosed above and in the appended claims.

1. A method for updating a software component in a distributed software system comprising a first software component and one or more second software components, said method comprising
updating said first software component with a new version of software substantially compatible with the functionality of a non-updated version(s) of said one or more second software components but having data structures incompatible with said non-updated version(s) of said one or more second software components,
providing said updated software version with a data exchange metadata description containing information on definitions of data structures to be used in a serialized data exchange,
delivering said metadata description with said new version of said software component.

2. A method as claimed in claim 1, further comprising
providing a dedicated data exchange metadata description for each version of said second software component that should be compatible, each said data exchange metadata description containing information on data structures to be used in a serialized data exchange by the respective version of said second software component,
delivering each of said dedicated data exchange metadata descriptions with the delivery of the respective version of said second software component,
delivering said dedicated data exchange metadata description separately for each data exchange session during a session handshake procedure between said new version of said software component and the respective version of said second software component.

3. A method as claimed in claim 1 or 2, further comprising
verifying the backward compatibility of said new version of said first software component prior to said delivery on the basis of said metadata description of said new version and the metadata description of previous version(s) of said second software component.

4. A method as claimed in claim 1 or 2, comprising
delivering said first software component to a server computer to be used as a server software component in a client-server-type distributed software system, said one or more second software components being client software components located in respective client stations.

5. A method for updating a software component in a distributed software system comprising a first software component and one or more second software components, said method comprising
updating said first software component with a new version of software substantially compatible with the functionality of a non-updated version(s) of said one or more second software components but having data structures incompatible with said non-updated version(s) of said one or more second software components,
providing said updated software version with a data exchange metadata description containing information on data structures to be used in a serialized data exchange,
providing a dedicated data exchange metadata description for each version of said second software component that should be compatible, each said data exchange metadata description containing information on data structures to be used in a serialized data exchange by the respective version of said second software component,
delivering said data exchange metadata descriptions with said new version of said software component.

6. A method as claimed in claim 5, further comprising
verifying the backward compatibility of said new version of said first software component prior to said delivery by comparing said metadata description of said new version with the metadata description of previous version(s) of said second software component.

7. A method for updating a software component in a distributed software system comprising a first software component and one or more second software components installed apart from each other, said method comprising
updating said first software component with a new version of software substantially compatible with the functionality of a non-updated version(s) of said one or more second software components but having data structures incompatible with said non-updated version(s) of said one or more second software components,
providing said updated software version with a data exchange metadata description containing information on data structures to be used in a serialized data exchange,
providing a dedicated data exchange metadata description for each version of said second software component that should be compatible, each said data exchange metadata description containing information on data structures to be used in a serialized data exchange by the respective version of said second software component,
verifying backward compatibility for at least one pair of said new version of said first software component and a previous version of said second software component on the basis of said metadata descriptions of these versions.

8. A method for updating a software component in a distributed software system comprising a first software component and one or more second software components installed apart from each other, said method comprising
updating said first software component with a new version of software substantially compatible with the functionality of a non-updated version(s) of said one or more second software components but having data structures incompatible with said non-updated version(s) of said one or more second software components,
providing said updated software version with a data exchange metadata description containing information on data structures to be used in a serialized data exchange,
providing a dedicated data exchange metadata description for each version of said second software component that should be compatible, each said data exchange metadata description containing information on data structures to be used in a serialized data exchange by the respective version of said second software component,
verifying backward compatibility and creating a serialization scheme for at least one pair of said new version of said first software component and a previous version of said second software component on the basis of said metadata descriptions of these versions, said serialization scheme containing information needed in said new version of said first software component for the serialization of data to and the deserialization of data from said respective previous version of said second software component,
delivering said at least one serialization scheme with said new version of said software component.

9. A method as claimed in claim 8, wherein said verifying comprises
loading the data exchange metadata descriptions of said version and a previous version of said first software component,
comparing the identifier and type information of data structures in said new version and said previous version,
checking that all compatible structures exist,
checking that data items with compatible types exist, and
checking that there is a default value for each data item added to or removed from said new version in comparison with said previous version.

10. A method for exchanging data between software components in a distributed software system comprising a first software component and a second software component, said method comprising
providing said first software component with a first data exchange metadata description containing information on data structures to be used in a serialized data exchange by said first software component,
providing said first software component with a dedicated second data exchange metadata description for any older version of said second software component that should be compatible, each said data exchange metadata description containing information on data structures to be used in a serialized data exchange by the respective version of said second software component,
said first software component identifying a version of a second software component,
said first software component selecting one of said second data exchange metadata descriptions corresponding to said identified version of said second software component,
said first software component serializing data items using data structures according to said first data exchange metadata description and said selected second data exchange metadata description, and sending said serialized data items to said second software component,
said first software component receiving serialized data items from said second software component and deserializing said data items using data structures according to said first data exchange metadata description and said selected second data exchange metadata description.

11. A method for exchanging data between software components in a distributed software system comprising a server software component and client software components, said method comprising
providing said server software component with a first data exchange metadata description containing information on data structures to be used in a serialized data exchange by said server software component, said server software component identifying a version of a client software component,
said server software component selecting according to said identified version of said client component a second data exchange metadata description,
said second data exchange metadata description containing information on data structures for said identified version of said client software component that are incompatible with the data structures of the version of said server software component,
said server software component serializing data items on the basis of said first data exchange metadata description and said selected second data exchange metadata description, and sending said serialized data items to said client software component,
said server software component receiving serialized data items from said client software component and deserializing said data items on the basis of said first data exchange metadata description and said selected second data exchange metadata description.

12. A method as claimed in claim 11, further comprising delivering said selected second data exchange metadata description either by
delivering said second metadata description with said server software component and storing it said server software component, or by
delivering said second metadata description during a data exchange session performed between said server software component and said identified version of said client software component.

13. A method as claimed in claim 11, comprising
creating a serialization scheme for said server software component and said identified version of said client software component on the basis of said metadata descriptions of these versions, said serialization scheme containing information needed in said server software component for the serialization of data to and the deserialization of data from said version of said client software component.

14. A method as claimed in claim 13, comprising
storing the created serialization scheme in said server software component,
using said stored serialization scheme in a subsequent data exchange session between said server software component and said identified version of said client software component.

15. A method as claimed in claim 11, wherein
said step of serializing comprises transforming data items into a stream of data bits to be sent to said client software component,
said step of deserializing comprises transforming a stream of bits received from said client software components into data items.

16. A method as claimed in claim 15, comprising
assigning a short identifier for each distinct instance of a data structure transferred in a data exchange operation,
sending and serializing that short identifier for each occurrence of each instance of a data structure,
serialising and sending each actual data structure instance only for the first occurrence within the data exchange operation instead of serializing the actual data structure instance for each occurrence within the data exchange operation.

17. A method for exchanging data between software components in a distributed software system comprising a first software component and a second software component, said method comprising
storing in said first software component a serialization scheme for at least one pair of said new version of said first software component and an older version of said second software component, said serialization scheme containing information needed in said new version of said first software component for the serialization of data to and the deserialization of data from said respective previous version of said second software component, and said serialization scheme being created on the basis of a first data exchange metadata description and a second data exchange metadata description, said first data exchange metadata description containing information on data structures to be used in a serialized data exchange by said first software component, and said second data exchange metadata description of said older version of said second software component containing information on data structures to be used in a serialized data exchange by the respective version of said second software component,
said first software component identifying a version of a second software component,
said first software component selecting serialization scheme corresponding to said identified version of said second software component,
said first software component serializing data items on the basis of said selected serialization scheme,
said first software component receiving serialized data items from said second software component and deserializing said data items on the basis of said selected serialization scheme.

18. A distributed computer system, comprising
a first software component,
one or more second software components exchanging serialized data with said first software component,
at least one of said second software components being an older version substantially compatible with the functionality of said first software component but having incompatible data structures,
said first software component having a first data exchange metadata description containing information on data structures to be used in a serialized data exchange by said first software component,
said first software component having a dedicated second data exchange metadata description for at least one older version of said second software component, each second data exchange metadata description containing information on data structures to be used in a serialized data exchange by the respective version of said second software component.

19. A distributed computer system as claimed in claim 18, wherein said computer system is a client-server-type computer system, and wherein said first software component is a server software component, and wherein said second software component is a client software component.

20. A distributed computer system as claimed in claim 18 or 19, wherein said first software component is installed in a first computer, and wherein said one or more second software components are installed in one or more second computers.

21. A client-server computer system, comprising
a server software component,
one or more client software components exchanging serialized data with said server software component,
said server software component having a first data exchange metadata description containing information on data structures to be used in a serialized data exchange by said server software component,
said server software component having a dedicated second data exchange metadata description for at least one older version of said client software component, each second data exchange metadata description containing information on data structures to be used in a serialized data exchange by the respective version of said second software component.

22. A client-server computer system as claimed in claim 21, comprising a routine configured to create a serialization scheme for said server software component and said older version of said client software component from said metadata descriptions of these versions, said serialization scheme containing information needed in said server software component for the serialization of data to and the deserialization of data from said older version of said client software component.

23. A client-server computer system as claimed in claim 21 or 22, wherein said server software component comprises a serialization routine configured to transform data items into a stream of data bits to be sent to said client software component, and a deserialization routine configured to transform a stream of bits received from said client software components into data items.

24. A client-server computer system as claimed in claim 21, wherein said first software component is installed in a first computer, and wherein said one or more second software components are installed in one or more second computers.

25. A server computer for a client-server computer system, comprising means for exchanging data with client software components, said means further comprising
means for storing a first data exchange metadata description containing information on data structures to be used in a serialized data exchange by said server software component,
means for identifying a version of a client software component,
means for selecting according to said identified version of said client component one of second data exchange metadata descriptions, said selected second data exchange metadata description containing information on data structures to be used in a serialized data exchange by the respective version of said second software component,
means for serializing data items on the basis of said first data exchange metadata description and said selected second data exchange metadata description, and sending said serialized data items to said client software component,
means for receiving serialized data items from said client software component and deserializing said data items on the basis of said first data exchange metadata description and said selected second data exchange metadata description.

26. A computer for a distributed software system comprising a first software component and at least one second software component, said computer comprising said first software component and means for exchanging data with said at least one second software component, said means further comprising
means for storing a serialization scheme for at least one pair of said new version of said first software component and an older version of said second software component, said serialization scheme containing information needed in said new version of said first software component for the serialization of data to and the deserialization of data from said previous version of said second software component, and said serialization scheme being created on the basis of a first data exchange metadata description and a second data exchange metadata description, said first data exchange metadata description containing information on data structures to be used in a serialized data exchange by said first software component, and said second data exchange metadata description of said older version of said second software component containing information on data structures to be used in a serialized data exchange by the respective version of said second software component,
means for identifying a version of a second software component,
means for selecting one serialization scheme corresponding to said identified version of said second software component,
means for serializing data items on the basis of said selected serialization scheme,
means for receiving serialized data items from said second software component and deserializing said data items on the basis of said selected serialization scheme.

27. A server computer program comprising a program code configured to perform the following routines when run on a computer,
identifying a version of a client software component,
selecting according to said identified version of said client software component of first data exchange metadata descriptions, said selected first data exchange metadata description containing information on data structures to be used in a serialized data exchange by the identified version of said client software component,
serializing data items using data structures according to said selected first data exchange metadata description and a second data exchange metadata description containing information on data structures to be used in a serialized data exchange by said server software component,
sending said serialized data items to said client software component,
receiving serialized data items from said client software component and deserializing said data items using data structures according to said selected first data exchange metadata description and a second data exchange metadata description.

28. A server computer program as claimed in claim 27, further configured to perform the following routine:
create a serialization scheme for said server software component and said identified version of said client software component on the basis of said metadata descriptions of these versions, said serialization scheme containing information needed in said server software component for the serialization of data to and the deserialization of data from said version of said client software component.

29. A server computer program as claimed in claim 27 or 28, wherein said program code is further configured to perform the following routines:
transforming data items into a stream of data bits to be sent to said client software component,
transforming a stream of bits received from said client software components into data items.

30. A server computer program as claimed in claim 27 or 28, wherein said program code is further configured to perform the following routines:
assigning a short identifier for each instance of a data structure transferred in a data exchange,
serializing and sending a short identifier of a data structure instead of the actual data structure when such short identifier is available.

31. A server computer program comprising a program code configured to perform the following routines when run on a computer,
storing a serialization scheme for at least one pair of said new version of said first software component and an older version of said second software component, said serialization scheme containing information needed in said new version of said first software component for the serialization of data to and the deserialization of data from said respective previous version of said second software component, and said serialization scheme being created on the basis of a first data exchange metadata description and a second data exchange metadata description, said first data exchange metadata description containing information on data structures to be used in a serialized data exchange by said first software component, and said second data exchange metadata description of said older version of said second software component containing information on data structures to be used in a serialized data exchange by the respective version of said second software component,
identifying a version of a second software component,
selecting a serialization scheme corresponding to said identified version of said second software component,
serializing data items on the basis of said selected serialization scheme,
receiving serialized data items from said second software component and deserializing said data items on the basis of said selected serialization scheme.

32. A computer program comprising program code means for performing all the steps of any one of claims 1 to 17 when the program is run on a computer.
